(19) United States
(12) Patent Application Publication
(10) Pub. No.: US 2013/0225330 A1
(43) Pub. Date: Aug. 29, 2013

(54) Golf Ball Having Larger Lower Density Inner Core And Thinner Higher Density Outer Core

(71) Applicants: Seisuke Tomita, Tokyo (JP); Thomas J. Kennedy, III, Wilbraham, MA (US)

(72) Inventors: Seisuke Tomita, Tokyo (JP); Thomas J. Kennedy, III, Wilbraham, MA (US)

(73) Assignee: NIKE, INC., Beaverton, OR (US)

(21) Appl. No.: 13/406,413

(22) Filed: Feb. 27, 2012

(51) Int. Cl. A63B 37/06; B23P 17/04; C08L 33/12; C08L 75/04; C08L 23/02

(52) U.S. Cl. 473/374; 525/125; 29/592

(57) ABSTRACT

A golf ball having a relatively larger, lower density inner core, and a relatively thinner, higher density outer core such that the ball has a relatively large moment of inertia (MOI) to generate an improved spin rate profile. The inner core is a blend of highly neutralized acid polymer and metallocene-catalyzed polymer, and the golf ball has a cover surrounding the inner layers. Also, an “on demand” method and system for making such golf balls.

The present disclosure relates generally to a golf ball comprising a relatively larger, lower density inner core, and a relatively thinner, higher density outer core surrounding the inner core such that the ball has a relatively large moment of inertia. Therefore, it is not only more difficult to initiate spin than a higher density core golf ball, but also the high moment of inertia golf ball will maintain the golf ball spin longer. The inner core comprises a blend of one or more highly neutralized acid polymers and one or more metallocene-catalyzed polymers; and the outer core comprises one or more highly neutralized acid polymers.

Golf balls have undergone significant changes over the years. For example, rubber cores have gradually replaced wound cores because of consistent quality and performance benefits such as reducing of driver spin for longer distance. Other significant changes have also occurred in the cover and dimple patterns on the golf ball.

The design and technology of golf balls has advanced to the point that the United States Golf Association (“USGA) has instituted a rule prohibiting the use of any golf ball in a USGA-sanctioned event that can achieve an initial velocity of 255 ft/s (250 ft/s, plus a 2 percent allowance) when struck by a driver having a velocity of 130 ft/s (referred to hereafter as“the USGA test”.) (The Royal and Ancient Club St. Andrews (“R&A”) has instituted a similar rule for R&A-sanctioned events.) Manufacturers place a great deal of emphasis on producing golf balls that consistently achieve the highest possible velocity in the USGA test without exceeding the limit. Even so, golf balls are available with a range of different properties and characteristics, such as velocity, spin, and compression, Thus, a variety of different balls may be available to meet the needs and desires of a wide range of golfers.

Regardless of construction, many players often seek a golf ball that delivers maximum distance. Balls of this nature typically require a high initial velocity upon impact. As a result, golf ball manufacturers are continually searching for new ways in which to provide golf balls that deliver the maximum performance for golfers at all skill levels, and seek to discover compositions that allow a lower compression ball to provide the performance generally associated with a high compression ball.

Balls having a solid construction are generally most popular with the average recreational golfer because they provide a very durable ball while also providing maximum distance. Solid balls may comprise a single solid core, often made of cross-linked rubber such as polybutadiene which may be chemically cross-linked with zinc diacrylate and/or similar cross-linking agents, and then encased within a cover material, such as SURLYN® (the trademark for an ionomer resin produced by DuPont) to provide a tough, cut-proof blended cover, often referred to as a “two-piece” golf ball.

The feel or compression of a golf ball also is important to a golfer. A softer or lower compression golf ball usually is preferred. This is known as a soft feel.

Generating spin on the golf ball allows for lift in accordance with Bernoulli's theorem. A higher moment of inertia golf ball maintains the spin of the golf ball longer.

A high coefficient of restitution (COR) or high speed resilience also is important for the performance of a golf ball.

Thus, there remains a need for a golf ball that provides good feel when struck, a high moment of inertia so as to maintain spin, and a high coefficient of restitution (COR) for improved velocity.

### SUMMARY

In a first aspect, the disclosure provides a golf ball having: an inner core and an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to 99.5% of one or more highly neutralized acid polymers and from about 0.5 to about 99.5% one or more metallocene-catalyzed polymers and a specific gravity between about 0.85 and about 0.95; wherein the outer core comprises one or more highly neutralized acid polymers and a specific gravity greater than about 1.2. In some aspects, the cover has a specific gravity greater than about 1.2.

In a second aspect, a method is provided which comprises the following steps: (a) providing one or more golf ball specifications to a golf ball making system; and (b) based on the one or more golf ball specifications provided to the golf ball making system in step (a), preparing one or more golf balls comprising: an inner core; an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to about 99.5% of one or more highly neutralized acid polymers and from about 0.5 to about 99.5% one or more metallocene-catalyzed polymers and a specific gravity of between about 0.85 and about 0.95; wherein the outer core comprises one or more highly neutralized acid polymers and a specific gravity greater than about 1.2. In some aspects, the cover has a specific gravity greater than about 1.2.

In a third aspect, a system is provided which comprises: an input terminal for entering one or more golf ball specifications; and a processor to which is electronically transmitted the golf ball specifications entered into the input terminal so that one or more golf balls can be prepared based on the transmitted golf ball specifications; wherein the golf balls to be prepared comprise: an inner core; an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to 99.5% of one or more highly neutralized acid polymers and from about 0.5 to about 99.5% one or more metallocene-catalyzed polymers and a specific gravity between about 0.85 and about 0.95; wherein the outer core comprises one or more highly neutralized acid polymers and a specific gravity greater than about 1.2. In some aspects, the cover has a specific gravity greater than about 1.2.

In another aspect, the inner core of the golf ball further comprises a density-reducing composition and has a specific gravity of less than about 0.85, typically between about 0.75 and about 0.85.

Other changes, modifications, features, benefits, and advantages of the aspects of the disclosure will be, or will become, apparent to one of ordinary skill in the art upon examination of the following figures and detailed description. It is intended that all such changes, modifications, features, benefits, and advantages be included within this description and this summary, be within the scope of the disclosure, and be protected, as defined by the appended claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like reference numerals designate corresponding parts throughout the different views.

FIG. 1 is a perspective view of a golf ball;

FIG. 2 is a sectional view of an embodiment of a golf ball taken along line 2-2 of FIG. 1;

FIG. 3 is a sectional view of another embodiment of a golf ball also taken along line 2-2 of FIG. 1; and

FIG. 4 is schematic diagram illustrating an embodiment of a system for “on demand” blending of one or more highly neutralized acid polymers and one or more metallocene-catalyzed polymers in the inner core, as well as selecting appropriate outer core compositions, cover layer compositions, and layer thicknesses, for example, for making one or more golf balls based on identification of one or more golf ball specifications by a customer.

### DETAILED DESCRIPTION

The golf balls according to embodiments of the disclosure are provided with: an inner core; an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to 99.5% of one or more highly neutralized acid polymers and from about 0.5 to about 99.5% one or more metallocene-catalyzed polymers and a specific gravity of less than or equal to about 0.85; wherein the outer core comprises one or more highly neutralized acid polymers and a specific gravity greater than about 1.2. In some embodiments of the disclosure, the cover has a specific gravity greater than about 1.2. In other embodiments, the inner core further comprises a density-reducing composition and has a specific gravity of less than about 0.85, typically between about 0.75 and about 0.85. These golf balls are advantageous in providing, among other attributes, a higher moment of inertia, and thus an improved spin rate profile. An improved spin rate profile means a high moment of inertia so that the golf ball requires more energy to start it spinning but, once spinning, will maintain its spin longer. In other words, the golf ball will have less spin decay during its flight.

Embodiments of golf balls prepared according to the present disclosure may provide the ability for an “on demand” blending system with identification of one or more golf ball specifications by a customer for controlling, for example, the blending of the one or more highly neutralized acid polymers and the one or more metallocene-catalyzed polymers in the inner core, as well as the composition of the outer core, cover layer, and layer thicknesses, fc. This “on demand” aspect relates to a system wherein the golf ball may, for example, be designed “on the spot” per the customer's specification(s). The customer's specification may relate, for example, to the compositions (e.g., materials, proportions of materials) in the various components (e.g., inner core, outer core, cover layer) of the golf ball, but may also relate to the properties, characteristics, etc., of the golf ball, which may be designed into the ball by virtue of the knowledge of the properties and characteristics which may result from selected inner core, outer core, and cover layer compositions and thicknesses, for example.

In this regard, an embodiment of a method of the present disclosure includes the step of providing one or more golf ball specifications to a golf ball making system. Based on these golf ball specifications provided to the golf ball making system, one or more golf balls are prepared which comprise: an inner core and an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to 99.5% of one or more highly neutralized acid polymers and from about 0.5 to about 99.5% one or more metallocene-catalyzed polymers and a specific gravity of less than or equal to about 0.85; wherein the outer core comprises one or more highly neutralized acid polymers and a specific gravity greater than about 1.2. In some embodiments of the disclosure, the cover has a specific gravity greater than about 1.2. In another embodiment of the disclosure, the inner core further comprises a density reducing composition and has a specific gravity less than about 0.85, typically between about 0.75 and about 0.85.

In another embodiment of the present disclosure, a system is provided which comprises: an input terminal for entering one or more golf ball specifications. The system further includes a processor to which is electronically transmitted the golf ball specifications entered into the input terminal so that one or more golf balls can be prepared based on the transmitted golf ball specifications, wherein the golf balls to be prepared comprise: an inner core and an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples: wherein the inner core comprises, by weight, a blend of from about 0.5 to 99.5% of one or more highly neutralized acid polymers and from about 0.5 to about 99.5% one or more metallocene-catalyzed polymers and a specific gravity between about 0.85 and about 0.95; wherein the outer core comprises one or more highly neutralized acid polymers and a having a specific gravity greater than about 1.2. In embodiments of the disclosure, the cover has a specific gravity greater than about 1.2.

In another embodiment of the disclosure, the inner core further comprises a density reducing composition and has a specific gravity less than about 0.85, typically between about 0.75 and about 0.85.

### Definitions

It is advantageous to define several terms before describing the disclosure. It should be appreciated that the following definitions are used throughout this application.

Where the definition of terms departs from the commonly used meaning of the term, applicant intends to utilize the definitions provided below, unless specifically indicated.

For the purposes of this disclosure, the term “golf ball” refers to any generally spherically shaped ball which may be used in playing the game of golf.

For the purposes of this disclosure, the term “core” normally refers to those portions of a golf ball which are closer to or proximate the center of the golf ball. The core has multiple layers, wherein, for example, the centermost portion of the golf ball is the “inner core” and any surrounding core layers are “outer core.”

For the purposes of this disclosure, the term “mantle” generally refers to an optional layer or layers of a golf ball which may be positioned between the core layers and the outermost cover layer, and which may be proximate or adjacent to the cover.

For the purposes of this disclosure, the term “cover” generally refers to the outermost layer(s) of a golf ball, which often has a pattern of dimples (dimple pattern) on the outer surface thereof.

For the purposes of this disclosure, the term “dimple” refers to an indentation in or a protrusion from the outer surface of a golf ball cover that is used to control the flight of the golf ball. Dimples may be hemispherical (i.e., half of a sphere) or semi-hemispherical (i,e., a part or portion of a hemisphere) in shape, including various combinations of hemispherical and semi-hemispherical dimples, but may also be elliptical-shaped, square-shaped, polygonal-shaped, such as hexagonal-shaped, etc. Dimples which are more semi-hemispherical in shape may be referred to as being “shallower” dimples, while dimples which are more hemispherical in shape may be referred to as being “deeper” dimples.

For the purposes of this disclosure, the term “dimple pattern” refers to an arrangement of a plurality of dimples on the outer surface of the cover of a golf ball. The dimple pattern may comprise dimples having the same shape, different shapes, different arrangements of dimples within the pattern (both as to shape and/or size), and repeating subpatterns (i.e. a smaller pattern of dimples arranged within the dimple pattern), such as spherical triangular. In some embodiments, the total number of dimples in the dimple pattern may be in the range of from about 250 to about 500, for example, from about 300 to about 400. The total number dimples in the dimple pattern is often an even number (e.g., 336 or 384 dimples), but may also be an odd number (e.g., 333 dimples).

For the purposes of this disclosure, the term “total dimple volume” refers to the aggregate, total, combined volume of all dimples comprising the dimple pattern.

For the purposes of this disclosure, the term “golf ball specification” refers to any characteristic, parameter, property, or characteristic, which may be used to define the design, composition, for example, of a golf ball. Golf ball specifications may include one or more of; ball speed, degree of ball spin (e.g., low spin, high spin), composition of materials comprising inner core, outer core, mantle layer, cover, or other layers, ball hardness, ball softness, ball feel, ball flight, ball launch angle, ball distance, degree of ball control, ball dimple pattern, ball dimple number, and total dimple volume, for example.

For the purposes of this disclosure, the term “thermoplastic” refers to the conventional meaning of the term thermoplastic, i.e., a composition, compound, material, medium, or substance, which exhibits the property of a material, such as a high polymer, that softens when exposed to heat and generally returns to its original condition when cooled to room temperature (e.g., from about 20° C. to about 25° C.).

For the purposes of this disclosure, the term “thermoset” refers to the conventional meaning of the term thermoset, i.e., a composition, compound, material, medium, or substance, that is cross-linked such that it does not have a melting temperature, and cannot be dissolved in a solvent, but which may be swelled by a solvent.

For the purposes of this disclosure, the term “polymer” refers to a molecule having more than 30 monomer units, and which may be formed or result from the polymerization of one or more monomers or oligomers.

For the purposes of this disclosure, the term “oligomer” refers to a molecule having 2 to 30 monomer units.

For the purposes of this disclosure, the term “monomer” refers to a molecule having one or more functional groups and which is capable of forming an oligomer and/or polymer.

For the purposes of this disclosure, the term “ionomer” refers to a polymer having at least one carboxylic acid group, and which may be at least partially or completely neutralized by one or more bases (including mixtures of bases) to provide carboxylic acid salt moieties (or mixtures of carboxylic acid salt moieties). For example, the ionomer may comprise a mixture of carboxylic acid sodium and zinc salts monomers, such as the mixed ionomer used in making the ionomer resin sold under DuPont's trademark SURLYN® for cut-resistant golf ball covers.

For the purposes of this disclosure, the term “ionomer resin” refers to an oligomer or polymer which may comprise, or be formed from, one or more ionomer units or ionomers, and which may be a copolymer of one or more ionomers (such as methacrylic acid which is at least partially or completely neutralized) and one or more monomers or oligomers which is not an ionomer, such as, for example, ethylene.

For the purposes of this disclosure, the terms “highly neutralized acid polymer” and “highly neutralized ionomer polymer” (hereafter referred to collectively as “highly neutralized acid polymer” (HNP)) refer to polymers whose acid groups have been mostly countered by the addition of a counter-ion material. For example, the highly neutralized acid polymer may be neutralized to at least about 70%, including up to 100%, with a suitable cation source, such as magnesium (magnesium hydroxide), sodium (sodium hydroxide), zinc (zinc acetate), or lithium (lithium hydroxide). These highly neutralized acid polymers may have 95% or greater neutralization of the acid moieties. These highly neutralized acid polymers are copolymers of an ethylenically unsaturated carboxylic acid polymers, or a-olefin, a C₃₋₈ α,β-ethylenically unsaturated carboxylic acid or terpolymers of an ethylenically unsaturated carboxylic acid polymers, or a-olefin, a C₃₋₈ α,β-ethylenically unsaturated carboxylic acid, and a softening monomer, such as an alkyl acrylate and/or an alkyl methacrylate, wherein the alkyl groups may have from 1 to 8 carbon atoms. The a-olefin may be ethylene and the C₃₋₈ α,β-ethylenically unsaturated carboxylic acid may be acrylic acid or methacrylic acid. See U.S. Pat. Appln. 2009/0247323 (Rajagopalan et al.), published Oct. 1, 2009, the entire contents and disclosure of which is herein incorporated by reference, for examples of highly neutralized acid polymers.

For the purposes of this disclosure, the term “metallocene-catalyzed polymer” refers to those polymers which may be prepared from olefins which have been catalyzed by using one or more metallocene compounds. These metallocene-catalyzed polymers may be characterized as foamed or otherwise specific gravity reduced thermoplastic polymer compositions, may be non-grafted or grafted (for example, including one or more pendant functional groups such as maleic (e.g., maleic anhydride), fumaric, (e.g., fumaric anhydride), itaconic, (e.g., itaconic anhydride), acrylic, or acrylate). U.S. Pat. No. 5,824,746 (Harris et al.), issued Oct. 20, 1998; U.S. Pat. No. 6,025,442 (Harris et al.), issued Feb. 15, 2000; U.S. Pat. No. 6,756,436 (Rajagopalan et al.), issued June 29, 2004; U.S. Pat. Appln. No. 2009/0247323 (Rajagopalan et al.), published Oct. 1, 2009; and U.S. Pat. Appln. No. 2010/0190578 (Rajagopalan et al.), published Jul. 29, 2010, the entire contents and disclosures of which are herein incorporated by reference, for examples of metallocene-catalyzed polymers generally. See also U.S. Pat. No. 5,703,166 (Rajagopalan et al.), issued Dec. 30, 1997; U.S. Pat. No. 5,824,746 (Harris et al.), issued Oct. 20, 199; U.S. Pat. No. 5,981,658 (Rajagopalan et al.), issued Nov. 9, 1999; and U.S. Pat. No. 6,025,442 (Harris et al.), issued Feb. 15, 2000, the entire contents and disclosures of which are herein incorporated by reference, for examples of grafted metallocene-catalyzed polymers.

For the purposes of this disclosure, the term “olefin” refers to those organic monomers or oligomers which have at least one double bond. Olefins may be branched or linear, may be alkenes, alkadienes, and may be substituted or unsubstituted. Olefins may include, for example, one or more of: ethylene, propylene, butene, pentene, hexene, heptene, octene, and norbornene.

For the purposes of this disclosure, the term “metallocene compounds” refers to those metal complexes comprising a transition metal (e.g., iron) which is complexed with and sandwiched between a pair of cyclopentadienyl (substituted or unsubstituted) anions. Metallocene compounds may function as catalysts in polymerizing olefins to provide metallocene-catalyzed polymers. Metallocene compounds which may function as catalysts may include one or more of: ferrocene (bis(η⁵-cyclopentadieny)iron(II); cobaltocene (bis(η⁵-cyclopentadieny)cobalt(III)); chromocene (bis(η⁵-cyclopentadieny)chromium(II)); nickelocene (bis(η⁵-cyclopentadieny)nickel(II)); vanadocene (bis(η⁵-cyclopentadieny)vanadium(II)); etc.

For the purposes of this disclosure, the term “elastomer” refers to oligomers or polymers having the property of elasticity, and may be used interchangeably with the term “rubber” herein.

For the purposes of this disclosure, the term “polyisocyanate” refers to an organic molecule having two or more isocyanate functional groups (e.g., a diisocyanate). Polyisocyanates useful herein may be aliphatic or aromatic, or a combination of aromatic and aliphatic, and may include, but are not limited to, diphenyl methane diisocyanate (MDI), toluene diisocyanate (TDI), hexamethylene diisocyanate (HDI), dicyclohexylmethane diisocyanate (H₁₂MDI), and isoprene diisocyanate (IPDI).

For the purposes of this disclosure, the term “polyol” refers to an organic molecule having two or more hydroxy functional groups.

For the purposes of this disclosure, the term “polyurethane” refers to a polymer which is joined by urethane (carbamate) links, and which may be prepared, for example, from polyols (or compounds forming polyols such as by ring-opening mechanisms, e.g., epoxides) and polyisocyanates. Polyurethanes useful herein may be thermoplastic or thermosetting, but are thermoplastic when used in the cover. The soft segment of a thermoplastic polyurethane may also be partially cross-linked, for example, with a hyper branched or dendritic polyol, to provide improved scuff resistance, increased hardness, etc.

For the purposes of this disclosure, the term “polyurea” refers to a polymer which is joined by urea links, and which may be prepared, for example, from the reaction of amines and isocyanates or isocyanates and water.

For the purposes of this disclosure, the term “dendritic molecule” refers to a molecule which is a repeatedly branched (also referred to as “hyper branched”), which is often highly symmetrical in structure, and which may include monomers, oligomers, and/or polymers.

For the purposes of this disclosure, the terms “hyper branched polyol” or “dendritic polyol” refer interchangeably to dendritic molecules (monomers, oligomers, and/or polymers) which are repeatedly branched (hyper branched) and have a plurality of hydroxy functional groups (e.g., functional groups which comprise one or more hydroxy groups). “Hyper branched polyols” or “dendritic polyols” may include polyester polyols, polyether polyols, and polycarbonate diols, for example. For example, the polyester polyols may be “star-type” comprising a central polyol moiety derived from a diol having one or more hydroxy alkyl chains such as 2-hydroxymethyl-2-methyl-1,3-propanediol, with the polyol ester branches formed from one or more polyhydroxycarboxylic acids or derivatives thereof, such as bis-2-hydroxymethyl-propanoic acid.

For the purposes of this disclosure, the term “hydroxy valence” with reference to the terms “hyper branched polyol” and “dendritic polyol” refers to how many reactive hydroxy groups (or equivalents of hydroxy groups) are present in the molecule. For example, a hyper branched polyol having a hydroxy valence of from about 2.1 to about 36 means a polyol (or a mixture of polyols) having, on average, from about 2.1 to about 36 reactive hydroxy groups.

For the purposes of this disclosure, the term “other polyols” refers to polyols other than “hyper branched polyols” or “dendritic polyols.” These other polyols may include diols, triols, and higher alcohols, polyester polyols, polyether polyols, and polycarbonate diols, for example. For example, these other polyols may include “bio-renewable” polyether polyols (Le., those polyether polyols which have reduced impact on the environment during processing) such as one or more of polytrimethylene ether glycol, polytetramethylene ether glycol (PTMEG), etc., which have, for example, a hydroxyl value of 11.22 to 224.11 mg KOH/g. These “bio-renewable” polyether polyols, such as polytrimethylene ether glycols, may be derived, obtained, or extracted from bio-renewable resources, such as through a fermentation process of natural corn, rather by a synthetic chemical process.

For the purposes of this disclosure, the term “chain extender” refers to an agent which increases the molecular weight of a lower molecular weight polyurethane to a higher molecular polyurethane. Chain extenders may include one or more diols such as ethylene glycol, diethylene glycol, butane diol, hexane diol, etc.; triols such as trimethylol propane, glycerol, and polytetramethylene ether glycol.

For the purposes of this disclosure, the terms “scuff resistance” and “wear resistance” (hereafter collectively referred to as “scuff resistance”) refer to the ability of the material of the ball to resist marks, tears, removal of surface material, punctures, or the like (collectively referred to as “scuffs”) due to impacts with dub heads. Low scuff resistance manifests itself as corrugations or ‘hairs’ that stick up from the golf ball, or any other article subjected to strain rate higher than the material can accommodate. A scuff resistance test can be conducted in the following manner: a golf dub, or at least the head thereof, is mounted on a swing robot and then swung at the head speed of about 32 m/s. The club face is oriented for a square hit. The forward/backward tee position is adjusted so that the tee is four inches behind the point in the downswing where the club is vertical. The height of the tee and the toe-heel position of the dub relative to the tee are adjusted in order that the center of the impact mark was about ¾ of an inch above the sole and was centered toe to heel across the face. Three samples of each ball were tested. Each ball was hit three times.

Other methods may also be used to determine the scuff resistance, such as the methods described in the commonly assigned copending application titled “Golf Ball Wear indicator”, U.S. patent application Ser. No. 12/691,282, filed Jan. 21, 2010, in the name of Brad Tutmark.

For the purposes of this disclosure, the term “rebound resilience” refers to the material property of rubber or materials formulated to have rubber-like properties, where the rebound resilience is an indication of the hysteretic energy loss that may also be defined by the relationship between the storage modulus of the material and the loss modulus of the material. Rebound resilience is generally expressed as a percentage, where the percentage is inversely proportional to the hysteretic loss. For materials alone, the rebound resilience may be measured using any known method, such as ASTM D7121-05 standard protocol. Rebound resilience of the golf ball system may be measured by the coefficient of restitution (COR) of the material used in a component of the golf ball, by the COR of a separate portion(s) or a separate component(s) of a golf ball (e.g., cores, layers, and cover), or by the COR of the golf ball.

For the purposes of this disclosure, the term “moment of inertia (MOI)” refers to a measure of an object's resistance to changes in its rotation rate, and may be given in units of g-cm². The term MOI also refers interchangeably to the terms “mass moment of inertia” and “angular mass.” The MOI for a solid sphere is defined by the equation I=(⅖)MR², wherein I is the moment of inertia, M is the mass, and R is the radius.

For the purposes of this disclosure, the term “coefficient of restitution (COR)” refers to the ratio of velocity of an object before and after an impact. A COR of 1 represents a perfect elastic collision where no energy is lost due to the collision, while a COR of 0 represents a perfect inelastic collision, where all of the energy is dissipated during the collision.

COR often is determined by firing a golf ball by an air cannon at an initial velocity of 40 m/sec, and a speed monitoring device is located over a distance of 0.6 to 0.9 meters from the cannon. The golf ball strikes a steel plate positioned about 1.2 meters away from the air cannon and rebounds through the speed-monitoring device. The return velocity divided by the initial velocity is the COR.

For the purposes of this disclosure, the term “specific gravity (SG)” refers to the conventional meaning of the ratio of the density of a given solid (or liquid) to the density of water at a specific temperature and pressure.

For the purposes of this disclosure, the term “deflection” refers to the degree to which a structural element is displaced under load. The amount of deflection (deflection amount) may be used as a measure of the ability to compress the golf ball (or a component or components of the golf ball), and thus is a measure of the rebound resilience (i.e., COR).

For the purposes of this disclosure, the term “Shore D hardness” refers to a measure of the hardness of a material by a durometer, and especially the material's resistance to indentation. Shore D hardness may be measured with a durometer directly on the curved surface of the core, layer, cover, etc., according to ASTM method D2240. In other embodiments, the hardness may be measured using standard plaques.

For the purposes of this disclosure, the term “curved surface” refers to that portion of the surface of a golf ball, core layer or layers, core, cover, and the like, which is curved and which is used for measuring various properties and characteristics of the golf ball or any layer thereof.

Flying distance may be used as an index to evaluate the performance of a golf ball. Flying distance is affected by three primary factors: “initial velocity”, “spin rate”, and “launch angle”. Initial velocity is one of the primary physical properties affecting the flying distance of the golf ball. The coefficient of restitution (COR) may also be used as an alternate parameter for the initial velocity of the golf ball.

Another index which may be used to measure the performance of a golf ball is spin rate. The spin rate of a ball may be measured in terms of “back spin” and “side spin,” as these different types of spin have different impacts on the flight of the ball. The spin of the ball against the direction of flight is known as “back spin”. Any spin to the ball that is oriented at an angle to the direction of flight is “side spin”. Back spin generally affects the distance of the ball's flight. Side spin generally affects the direction of the ball's flight path.

The spin rate of the golf ball generally refers to the speed that the ball turns about a longitudinal axis through the center of the ball. The spin rate of the ball is often measured in revolutions per minute. Because the spin of the ball generates lift, the spin rate of the ball directly impacts the trajectory of the ball. A shot with a higher spin rate tends to fly to a higher altitude compared to a ball with a lower spin rate. Because the ball tends to fly higher with a higher spin rate, the overall distance traveled by a ball hit with an excessive amount of spin tends to be less than or equal to that of a ball hit with an ideal amount of spin. Conversely, a ball hit with an insufficient amount of spin may not generate enough lift to increase the carry distance, thus resulting in a significant loss of distance. Therefore, hitting a ball with the ideal amount of spin may maximize the distance traveled by the ball.

For the purposes of this disclosure, the term “computer” refers to any type of computer system that implements software including an individual computer such as a personal computer, mainframe computer, or mini-computer. In addition, computer system refers to any type of network of computers, such as a network of computers in a business, the Internet, personal data assistant (PDA), devices such as a cell phone, a television, a videogame console, a compressed audio or video player such as an MP3 player, a DVD player, or a microwave oven. A personal computer is one type of computer system that may include the following components: a case or chassis in a tower shape (desktop) and the following parts: motherboard, CPU, RAM, firmware, internal buses (PIC, PCI-E, USB, HyperTransport, CSI, AGP, VLB), external bus controllers (parallel port, serial port, USB, Firewire, SCSI, PS/2, ISA, EISA, MCA), power supply, case control with cooling fan, storage controllers (CD-ROM, DVD, DVD-ROM, DVD Writer, DVD RAM Drive, Blu-ray, BD-ROM, BD Writer, floppy disk, USB Flash, tape drives, SATA, SAS), video controller, sound card, network controllers (modem, NIC), and peripherals, including mice, keyboards, pointing devices, gaming devices, scanner, webcam, audio devices, printers, and monitors.

For the purposes of this disclosure, the term “processor” refers to a device capable of, for example, executing instructions, implementing logic, and calculating and storing values, for example. Exemplary processors may include application specific integrated circuits (ASIC), central processing units, microprocessors, such as, for example, microprocessors commercially available from Intel and AMD, and computers.

For the purposes of this disclosure, the term “in electronic communication” refers to two or more devices which are able to transmit electronic signals, data, for example, by a wired connection, wireless connection, or a combination of wired and wireless connections.

For the purposes of this disclosure, the term “display device” refers to a device (e.g., a monitor) which presents visual images from a computer for viewing. The display device may be incorporated as a component of the computer, or may be a separate device which is in electronic communication with the computer.

For the purposes of this disclosure, the term “transmission” refers to any type of transmission that may be carried out electronically by wired methods, wireless methods, or combinations thereof. Illustrative electronic transmissions may be carried out by a variety of remote electronic transmission methods, such as by using Local Area Network- or Wide Area Network (LAN or WAN)-based, Internet-based, or web-based transmission methods, cable television or wireless telecommunications networks, or other suitable remote transmission method.

For the purposes of this disclosure, the term “remotely accessible” (and related terms such as “remotely access”) refers to the ability to input, access, retrieve, download, or transmit data or software, for example, which is stored remotely from the user by using a remote electronic transmission method.

For the purposes of the present disclosure, the term “electronic database” refers to a database on which data is electronically stored on a computer, and which may be electronically accessed, for example, to input and retrieve data.

### DETAILED DESCRIPTION

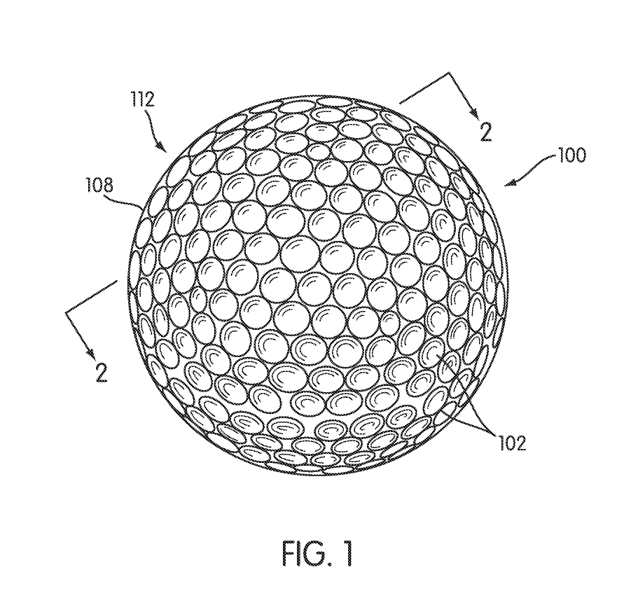

FIG. 1 is a perspective view of a solid golf ball 100 according to an embodiment of the disclosure. Golf ball 100 may be generally spherical in shape with a plurality of dimples 102 arranged on the outer surface 108 of golf ball 100 in a pattern 112.

On FIG. 1 surface 108 of the cover of golf ball 100 may include other features. For example, any number of dimples 102 may be provided on surface 108 of golf ball 100. In some embodiments, the number of dimples 102 may be in the range from about 250 to about 500. In other embodiments, the number of dimples 102 may be in the range from about 300 to about 400. As shown in FIG, 1, dimples 102 may be arranged on surface 108 of golf ball 100 in a triangular spherical pattern 112, as well as any other dimple patterns known to those skilled in the art.

Though shown as substantially hemispherical, dimples 102 may have any shape known in the art, such as semi-hemispherical, elliptical, or polygonal, such as hexagonal, for example. While in some embodiments dimples 102 may be protrusions extending outwardly from surface 108 of golf ball 100, dimples 102 normally comprise indentations in surface 108 of golf ball 100. Each indentation of each dimple 102 defines a dimple volume. For example, if dimple 112 is a hemispherical indentation in surface 108, the space carved out by dimple 112 and bounded by an imaginary line representing where surface 108 of golf ball 100 would be if no dimple 102 were present has a dimple volume of a hemisphere, or (⅔)πr³, where r is the radius of the hemisphere. In some embodiments, all dimples 102 may have the same or similar diameter or radius. In other embodiments, dimples 102 may be provided with different diameters or radii. In some embodiments, each dimple 102 may have a diameter or radius selected from a preselected group of diameters/radii. In other embodiments, the number of different diameters/radii in the preselected group of diameters/radii may be in the range of from three (3) to six (6). In some embodiments, the number of dimples 102 with the largest diameter/radius may be greater than the number of dimples with any other diameter/radius. In other words, in such an embodiment, there are more of the largest dimples than dimples of any other size. Dimples 102 may also be arranged in repeating subpatterns of dimples 102 which may have recognized geometries (e.g., pentagonal), and may comprise combinations of dimples having smaller and larger diameters/radii.

The aggregate of the volumes of all of dimples 102 on 108 surface of golf ball 100 may be referred to as a “total dimple volume.” In one embodiment, the total dimple volume may be in the range of from about 550 to about 800 mm³. In some embodiments, the total dimple volume may be in the range of from about 600 to about 800 mm³.

Internally, golf ball 100 may be generally constructed as a multilayer or multi-piece solid golf ball, having any desired number of layers or pieces. In other words, multiple layers of material may be fused, blended, or compressed together to form the ball. The physical characteristics of a golf ball may be determined by the combined properties of the core layers, any optional mantle layer(s), and the cover layer. The physical characteristics of each of these components may be determined by their respective chemical compositions. The majority of components in golf balls comprise oligomers or polymers. The physical properties of oligomers and polymers may be highly dependent on their composition, including the monomer units included, molecular weight, and degree of cross-linking, for example. Examples of such properties may include solubility, viscosity, specific gravity (SC), elasticity, hardness (e.g., as measured as Shore D hardness), rebound resilience, and scuff resistance. The physical properties of the oligomers and polymers used may also affect the industrial processes used to make the components of the golf ball. For example, where injection molding is the processing method used, extremely viscous materials may slow down the process and thus viscosity may become a limiting step of production.

For simplicity, this disclosure typically will be directed to three-piece or four-piece golf balls, but common layers, for example, the inner core, will not always be identified for both balls. Unless otherwise specifically identified, discussion of the core of the three-piece golf ball also applies to the core of the four-piece golf ball.

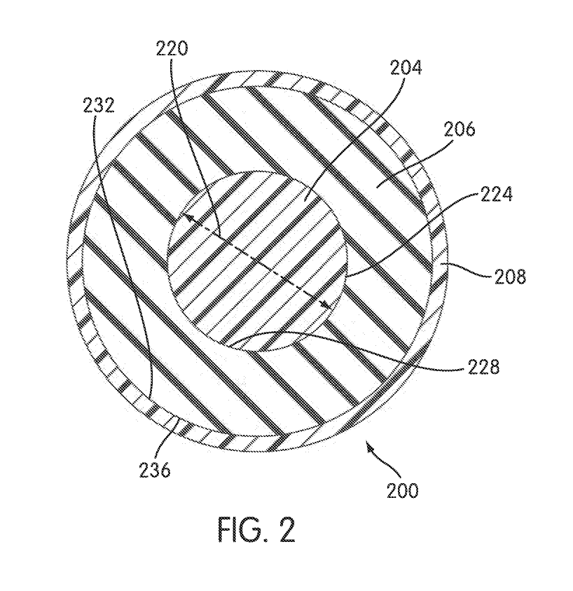

As shown in FIG. 2, one embodiment of such a golf ball (referred to generally as 200) includes an inner core 204, an outer core 206 surrounding inner core 204, and a cover 208 surrounding outer core 206. The ratio (in terms of radius and mass) of inner core 204 to outer core 206 so as to impart a moment of inertia (MOI) to the golf ball of at least about 86 g-cm², typically at least about 89 g-cm², and more typically at least about 92 g-cm². For example, the moment of inertia (MOI) for the golf ball may be in the range of from about 86 g-cm² to about 110 g-cm², typically from about 89 g-cm² to about 107 g-cm², and more typically between about 92 g-cm² and about 105 g-cm².

In some embodiments of the disclosure, inner core 204 or 304 may be made from a blend of one or more highly neutralized acid polymers (HNP) and one or metallocene-catalyzed polymers. The proportion of HNP in the blend ranges from about 0.5 wt percent to 99.5 wt percent of the total weight of HNP and metallocene-catalyzed polymers in the inner core, with metallocene-catalyzed polymers making up the remainder. Typically, the proportion of HNP in the blend is from about 1 wt percent to about 99 wt percent, more typically between about 5 wt percent and about 95 wt percent, more typically between about 10 wt percent and about 90 wt percent, and most typically between about 15 wt percent and about 85 wt percent, all of the HNP/metallocene-catalyzed blend.

The blend of HNP and metallocene-catalyzed polymer in these embodiments is manipulated to obtain a large, low-density core that provides suitable performance properties and characteristics, such as COR of at least about 0.785. The HNP provides COR values typically sufficient, when blended with metallocene-catalyzed polymer, to provide a core having a COR of at least about 0.785, typically from about 0.795 to about 0.89, and more typically from about 0.80 to about 0.88.

In various embodiments, inner core 204 may have certain physical properties. Inner core 204 may have a specific gravity between about 0.85 and about 0.95, typically in the range of from about 0.85 to about 0.92, and more typically from about 0.86 to about 0.90. Whereas the HNP typically may have a specific gravity of about 0.90 to about 0.98, for example, the metallocene-catalyzed polymer will have a lower specific gravity, typically between about 0.85 and about 0.90, although some specific gravity values will be out of this range.

For example, suitable highly neutralized acid polymers may include one or more of the HPF family of HNPs, commercially available from E. I. DuPont de Nemours and Company. For example, suitable HPF resins may be selected from the group consisting of HPF 1000, HPF 2000, HPF AD1027, HPF AD1035, HPF AD1040, members of the HPF SEP 1313 series, HPF RX-85, and blends thereof. The skilled practitioner recognizes that each of these products has different performance properties and characteristics and, with the guidance provided herein, will be able to formulate inner cores having desired properties and characteristics.

Suitable metallocene-catalyzed polymers for use in inner core 204 may be grafted or non-grafted, and may include one or more of those metallocene-catalyzed polymers disclosed in, for example, U.S. Pat. No. 5,824746 (Harris et al.), issued Oct. 20, 1998; U.S. Pat. No. 6,025,442 (Harris et al.), issued Feb. 15, 2000; U.S. Pat. No. 6,756,436 (Rajagopalan et al.), issued Jun. 29, 2004; U.S. Pat. Appln. No. 2009/0247323 (Rajagopalan et al.), published Oct. 1, 2009; and U.S. Pat. Appln. No. 2010/0190578 (Rajagopalan et al.), published Jul. 29, 2010, the entire contents and disclosures of which are herein incorporated by reference.

Grafted mnetallocene-catalyzed polymers may be conventionally neutralized with metal cations, but may also be neutralized, either partially for fully, with organic acids or salts thereof and an appropriate base. Grafted metallocene-catalyzed polymers may include those disclosed in, for example, U.S. Pat. No. 5,703,166 (Rajagopalan et al.), issued Dec. 30, 1997; U.S. Pat. No. 5,824,746 (Harris et al.), issued Oct. 20, 1998; U.S. Pat. No. 5,981,658 (Rajagopalan et al.), issued Nov. 9, 1999; and U.S. Pat. No. 6,025,442 (Harris et al.), issued Feb. 15, 2000, the entire contents and disclosures of which are herein incorporated by reference. These grafted metallocene-catalyzed polymer may also be available from DuPont under the tradenames SURLYN® NMO 5250, SURLYN® NMO 524D, and SURLYN® NMO 4990, all formerly known as the FUSABOND® family of polymers, or may be obtained by subjecting a non-grafted metallocene-catalyzed polymer to a post-polymerization reaction to provide a grafted metallocene-catalyzed polymer with the desired pendant group or groups.

Examples of metallocene-catalyzed polymers to which functional groups may be grafted for use in inner core 204 may include homopolymers of ethylene and copolymers of ethylene and a second olefin, such as, propylene, butene, pentene, hexene, heptene, octene, and norbornene. Metallocene-catalyzed copolymers or terpolymers can be random or block and may be isotactic, syndiotactic, or atactic. The pendant groups creating the isotactic, syndiotactic, or atactic polymers are chosen to determine the interactions between the different polymer chains making up the resin to control the final properties of the resins used in golf ball covers, centers, or intermediate layers.

Grafted metallocene-catalyzed polymers useful in inner core 204 may be formed from metallocene-catalyzed random or block copolymers or terpolymers. Non-grafted metallocene-catalyzed polymers useful in inner core 204 may be commercially available under the trade name AFFINITY® polyolefin plastomers and ENGAGE® polyolefin elastomers commercially available from Dow Chemical Company and DuPont-Dow. Other commercially available metallocene-catalyzed polymers may be used, such as EXACT®, commercially available from Exxon and INSIGHT®, commercially available from Dow. The EXACT® and INSIGHT® line of polymers may also have novel rheological behavior in addition to their other properties as a result of using a metallocene catalyst technology. Metallocene-catalyzed polymers may also readily available from Sentinel Products Corporation of Hyannis, Mass., as foamed sheets for compression molding.

Olefinic monomers useful in making these metallocene-catalyzed polymers for inner core 204 may include one or more olefinic monomers having, as a functional group, sulfonic add, sulfonic add derivatives, such as chlorosulfonic acid, vinyl ethers, vinyl esters, primary, secondary, and tertiary amines, mono-carboxylic acids, dicarboxylic acids, partially or fully ester-derivatized mono-carboxylic and dicarboxylic acids, anhydrides of dicarboxylic acids, and cyclic imides of dicarboxylic acids. In addition, metallocene-catalyzed polymers may also be functionalized by sulfonation, carboxylation, or the addition of an amine or hydroxy group. These metallocene-catalyzed polymers functionalized by sulfonation, carboxylation, or the addition of a hydroxy group may be converted to anionic ionomers by treatment with a base. Similarly, metallocene-catalyzed polymers functionalized by the addition of an amine may be converted to cationic ionomers by treatment with an alkyl halide, acid, or acid derivative. The olefinic monomer maleic anhydride may be attached to the metallocene-catalyzed polymer by the post-polymerization reaction, and may be further subjected to a reaction to form a grafted metallocene-catalyzed polymer containing other pendant or functional groups. For example, reaction with water may convert the anhydride to a dicarboxylic acid; reaction with ammonia, alkyl, or aromatic amine forms an amide; reaction with an alcohol results in the formation of an ester; and reaction with base may result in the formation of an anionic ionomer.

Typically, increasing the proportion of metallocene-catalyzed polymer reduces both the COR and the specific gravity of the blend, whereas increasing the HNP composition typically increases both the COR and the specific gravity in the resultant core. The combination provides a golf ball core with reduced compression, and therefore a softer ball, without sacrificing significant performance properties and characteristics provided by the HNP.

In some embodiments of the disclosure, the inner core further comprises a density reducing composition that lowers the specific gravity of the inner core to less than about 0.85, typically between about 0.70 and about 0.85, and more typically between about 0.75 and about 0.83. Reducing the density of the inner core makes it possible to increase the MOI by shifting mass away from the center of the ball to the periphery.

Various density reducing compositions have a specific gravity less than about 0.85, or less than about 0.70, Such compositions include, but are not limited to, hollow forms, such as hollow glass beads or polymeric beads; materials, such as gases, that foam the blend of HNP and metallocene-catalyzed polymer; and Expancel® products, hollow thermoplastic beads that contain gas under pressure. Expancel® beads, available from Akzo Nobel, may be heated to foam the inner core material.

The density reducing compositions also tend to reduce COR as they reduce density. In these embodiments of the disclosure, the COR typically is at least about 0.750, and more typically is between about 0.750 and about 0.780.

With the guidance provided herein, the skilled practitioner will be able to identify blends for the core that will provide a golf ball having suitable performance properties and characteristics. In addition to blending the polymeric compositions, other additives also may be included.

Suitable highly neutralized acid polymers for use in forming inner core 204 may comprise a highly neutralized acid polymer and optionally additives, fillers, and/or melt flow modifiers. For example, the HNPs may be neutralized to at least about 70%, including up to 100%, with a suitable cation source, such as magnesium, sodium, zinc, or potassium. To increase COR, one composition of inner core 204 may include HPF as the main ionomer resin composition with SURLYN® and/or IOTEK® as optional sub-compositions. Any sub-composition of inner core 204 may be in an amount of from 0 to about 10 parts by weight, based on 100 parts by weight of the main ionomer resin composition of inner core 204.

The highly neutralized acid polymers for use in inner core 204 may have a Shore hardness of from about 20 to about 80, for example, from about 30 to about 75, and typically between about 35 and about 70.

In some embodiments, inner core 204 may have a diameter, indicted in FIG. 2 by dashed double-headed arrow 220, in a range between about 19 mm and about 40 mm. In some embodiments, diameter 220 of inner core 204 may be in the range from about 20 to about 38 mm. In some embodiments, diameter 220 of inner core 204 may be in the range from about 21 to about 37 mm. In some embodiments, diameter 220 of inner core 204 may range between about 25 mm and 37 mm.

Other suitable additives and fillers for inclusion in inner core 204 may include, for example, blowing and foaming agents, optical brighteners, coloring agents, fluorescent agents, whitening agents, UV absorbers, light stabilizers, defoaming agents, processing aids, antioxidants, stabilizers, softening agents, fragrance components, plasticizers, impact modifiers, acid copolymer wax, surfactants, and low density fillers, such as hollow spheres or microspheres, which may be incorporated into the polymer matrix comprising inner core 204. Suitable melt flow modifiers may include, for example, one or more of fatty acids and salts thereof, polyamides, polyesters, polyacrylates, polyurethanes, polyethers, polyureas, and polyhydric alcohols, for example. Such additives are included in inner core 204 in amounts considered by skilled practitioner to be typical amounts. For example, in particular, the skilled practitioner recognizes that coloring agents and whiteners are less likely to be used in an inner core layer.

Inner core 204 may be made by a fabrication method such as hot-press molding or injection molding, and may comprise a single layer or multilayer construction. In one embodiment, the surface of inner core 204 may be placed in hemispherical cups which may be roughened before the placement to increase adhesion between inner core 204 and outer core 206. In some embodiments, the surface layer of inner core 204 may be pre-coated with an adhesive or pre-treated with chemical(s) before placing inner core 204 in the hemispherical cups to enhance the durability of the golf ball and enable a high rebound.

The outer core and additional layers, to and including the outer cover, must be of dimensions and compositions having properties and characteristics to result in a ‘regulation golf ball,’ if the golf ball is intended for play under the rules of the various sanctioning bodies, such as the United States Golf Association and the parallel organizations in other countries. In particular, a ‘regulation’ golf ball has a maximum weight of 1.62 ounces, or 45.93 g, and a minimum diameter of 1.68 inches, or 42.67 mm. Thus, in accordance with embodiments of the disclosure, layers other than the inner core layer typically will be dense, to further limit spin, and will be relatively thin.

Outer core 206 or 306 may comprise any composition typically used in an outer core layer, including thermoplastic elastomers one or more highly neutralized acid polymers which are the same or different from the highly neutralized acid polymers present in inner core 204. In addition to the highly neutralized acid polymers, outer core 206 may also comprise one or more other thermoplastic materials selected from the group consisting of polyamide resins, polyester resins, and polyurethane resins, as well as one or more thermoset materials selected from the group consisting of polyurethane elastomers, polyamide elastomers, polyurea elastomers, diene-containing polymers (such as polybutadiene), silicones, and blends thereof.

In embodiments, the HNP that forms the outer core layer is selected from the same HNPs that may be used in the inner core. Thus, suitable HPF resins may be selected from the group consisting of HPF 1000, HPF 2000, HPF AD1027, HPF AD1035, HPF AD1040, members of the HPF SEP 1313 series, HPF RX-85, and blends thereof.

In embodiments, the HNP is densified with materials typically used to densify a layer comprising HNP. For example, one or more high density fillers (e.g., fillers having specific gravities in the range from about 2 to about 19) are suitably used. The high density filler may be used to increase the specific gravity of outer core 206. The high density filler (e.g., metal powder, metal oxides, metal carbonates, metal sulfates) may include one or more of: bismuth powder, boron powder, brass powder, bronze powder, cobalt powder, copper powder, inconel metal powder, iron metal powder, molybdenum powder, nickel powder, stainless steel powder, titanium metal powder, zirconium oxide powder, aluminum flakes, tungsten metal powder, beryllium metal powder, zinc metal powder, tin metal powder, manganese powder, and magnesium powder, zinc oxide, iron oxide, aluminum oxide, titanium dioxide, magnesium oxide, zirconium oxide, tungsten trioxide, particulate carbonaceous materials such as graphite and carbon black, graphite fibers, precipitated hydrated silica, clay, talc, glass fibers, aramid fibers, mica, calcium metasilicate, barium sulfate, zinc sulfide, silicates, diatomaceous earth, calcium carbonate, magnesium carbonate, and regrind (i.e., recycled uncured center material mixed and ground to, for example, 30 mesh particle size). In some embodiments, high density fillers such as one or more of zinc oxide, barium sulfate, calcium carbonate, or magnesium carbonate may be advantageous.

Other compositions also may be used to form the outer core layer. For example, dynamically vulcanized thermoplastic elastomers, functionalized styrene-butadiene elastomers, thermoplastic rubbers, polybutadiene rubbers, natural rubbers, thermoset elastomers, thermoplastic urethanes, thermoset urethanes, ionomer resins, or blends thereof, also may be included in outer core 206. For example, an intermediate layer may include a thermoplastic or thermoset polyurethane. Non-limiting of commercially available dynamically vulcanized thermoplastic elastomers include SANTOPRENE®, SARLINK®, VYRAM®, DYTRON®, and VISTAFLEX®. SANTOPRENE® is a dynamically vulcanized PP/EPDM. Examples of functionalized styrene-butadiene elastomers, i.e., styrene-butadiene elastomers with functional groups such as maleic anhydride or sulfonic acid, include KRATON FG-1901x and FG-1921x, which are available from the Shell Corporation of Houston, Tex. Examples of suitable thermoplastic polyurethanes include ESTANE® 58133, ESTANE® 58134 and ESTANE® 58144, which are commercially available from Lubrizol of Cleveland, Ohio. The skilled practitioner recognizes the typical catalysts, initiators, fillers, and additives that typically can be combined with these compositions and, with the guidance provided herein, will be able to select suitable compounds and amounts thereof for use therein.

In various embodiments, outer core 206 or 306 may have certain physical properties. Outer core 206 or 306 has a specific gravity of at least about 1.2. For example, outer core 206 or 306 may have a specific gravity in the range of from about 1.2 to about 5.0, typically from about 1.3 to about 4.0. Outer core 206 may have a thickness of from about 0.1 mm to about 15 mm, typically from about 0.2 mm to about 8 mm, more typically from about 0.25 mm to about 5 mm, and even more typically from about 0.25 mm to about 2 mm.

Outer core 206 may be made by any suitable method, such as hot-press molding or injection molding.

An intermediate layer, such as a mantle layer or an inner cover layer 310, also is present in a four-piece golf ball. This mantle layer is thin and typically is dense. This intermediate layer 310 may have a thickness of from about 0.1 mm to about 10 mm, typically from about 0.15 mm to about 7 mm, more typically from about 0.2 mm to about 5 mm, and even more typically from about 0.25 mm to about 1 mm. The layer may comprise the same compounds and additives as may make up the outer core layer.

Cover 208 or 308 (which surrounds, encloses, or encompasses outer core 206 or mantle layer 310) has an outer surface that may include a dimple pattern comprising a plurality of dimples. Cover 208 may have a specific gravity equal to or greater than that of outer core 206 or mantle layer 310. Thus, in some embodiments, the specific gravity of the cover is at least about 1.2 to about 5.0 and is equal to or greater than the specific gravity of the outer cover, and typically is from about 1.3 to about 3.0 and is equal to or greater than the specific gravity of the outer cover. In other embodiments, the specific gravity of the cover is at least about 1.2 to about 5.0 and is equal to or less than the specific gravity of the outer cover, and typically is from about 1.3 to about 3.0 and is equal to or less than the specific gravity of the outer cover. Cover 208 may have any thickness, but, in some embodiments, may have a thickness ranging from about 0.5 to about 2 mm, and, in some embodiments from about 1.0 to about 1.5 mm. Cover 208 may have a Shore D hardness ranging from about 40 to about 73 as measured on the curved outer surface of cover 208. In some embodiments, the Shore D hardness may range from about 50 to about 60. Cover 208 may have a relatively higher spin rate.

Cover 208 may comprise any number of materials such as, for example, one or more of: ionomeric materials, thermoplastic materials, elastomeric materials, urethane, balata (natural or synthetic), polybutadiene, and the like. In one embodiment, at least one layer of the cover 208 may contain a crosslinkable thermoplastic polyurethane.

Cover 208 may also comprise a crosslinked thermoplastic polyurethane elastomer, wherein the crosslinked thermoplastic polyurethane elastomer includes hard segments and soft segments, the crosslinked thermoplastic polyurethane elastomer including crosslinks located in the hard segments, the crosslinks being the reaction product of unsaturated bonds located in the hard segments catalyzed by a free radical initiator, and wherein the cover layer has a flexural modulus of from about 200 psi to about 50,000 psi. See U.S. patent application Ser. No. 13/193,289, filed Jul. 28, 2011, the entire contents and disclosure of which is herein incorporated by reference. For example, this crosslinked thermoplastic polyurethane elastomer comprise the reaction product of an unsaturated diol of formula (1):

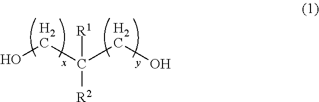

in which R¹ may be any substituted or unsubstituted alkyl, substituted or unsubstituted aryl, substituted or unsubstituted alkyl-aryl group, substituted or unsubstituted ether group, substituted or unsubstituted ester group, any combination of the above groups, or H, and may optionally include an unsaturated bond in any main chain or side chain of any group; R² may be any suitable substituted or unsubstituted alkyl, substituted or unsubstituted aryl, substituted or unsubstituted alkyl-aryl group, substituted or unsubstituted ether group, substituted or unsubstituted ester group, any combination of the above groups, and R² includes an allyl group; and x and y are integers independently having any value from 1 to 10. In another embodiment, this cover comprising this crosslinked thermoplastic polyurethane elastomer may impart the following characteristic to the cover; (1) a Shore D hardness on the golf ball from about 40 to about 65; and (2) a flexural modulus of from about 200 psi to about 10,000 psi.

In the embodiment shown in FIG. 2, outer core 206 surrounds, covers, encompasses, substantially encloses, etc., inner core 204. Outer core 206 has an interior surface 224 facing an exterior surface 228 of inner core 204. In the embodiment shown in FIG. 2, exterior surface 232 of outer core 206 faces an interior surface 236 of cover 208.

To increase the specific gravity of outer core 206, a suitable filler may be added in the rubber composition, such as zinc oxide, barium sulfate, calcium carbonate, magnesium carbonate, etc. In addition, a metal powder with a greater specific gravity may also be used as the filler, such as tungsten. By means of adjusting the added amount of the filler, the specific gravity of outer core 206 may be adjusted as desired.

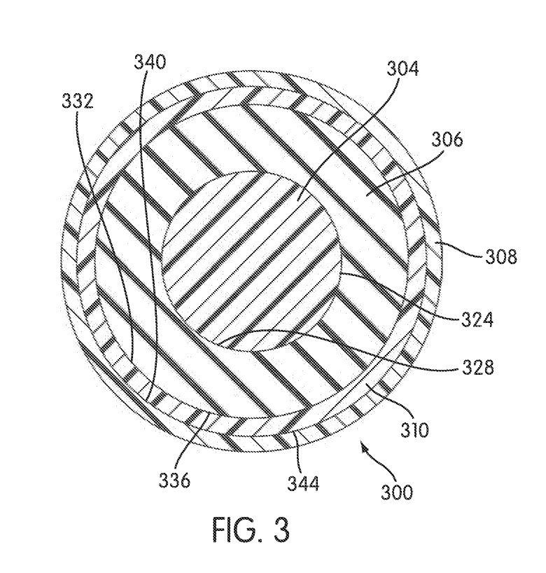

In the embodiment shown in FIG. 3, golf ball 300 may have an inner core 304, outer core 306 and cover 308 which may comprise the same materials, may have the same properties and may have the same diameters/thicknesses as, respectively, inner core 204, outer core 206, and cover 208 of the embodiment shown in FIG. 2. Golf ball 300 of FIG. 3 may also provided with an additional inner cover or mantle layer 310 positioned between cover 308 and outer core 306. In such an embodiment, cover 308 may also be considered to be an outer cover layer. Mantle layer 310 substantially encloses, surrounds, encompasses, etc., outer core 306. Mantle layer 310 may comprise the same material as that of cover 308, or may comprise a different material. For example, mantle layer 310 may comprise an at least partially neutralized thermoplastic ionomer resin or a urethane resin. In some embodiments, mantle layer 310 may have a specific gravity (SG) greater than that of outer core 306. To increase the specific gravity of mantle layer 310, a suitable filler may be added in the rubber composition, such as zinc oxide, barium sulfate, calcium carbonate, magnesium carbonate, etc. In addition, a metal powder with a greater specific gravity may also be used as the filler, such as tungsten. By means of adjusting the added amount of the filler, the specific gravity of mantle layer 310 may be adjusted as desired.

In the embodiment shown in FIG. 3, outer core 306 surrounds, covers, substantially encloses, etc., inner core 304. Outer core 306 has an interior surface 324 facing an exterior surface 328 of inner core 204. In the embodiment shown in FIG. 3, exterior surface 332 of outer core 306 faces an interior surface 336 of mantle layer 310. Mantle layer 310 has an exterior surface 340 that faces interior surface 344 of outer core 306.

In some embodiments, the exterior surface of mantle layer 310 has a higher hardness than the exterior surface of cover 308. In some embodiments, an exterior surface of mantle layer 310 may have a Shore hardness of from about 45 to about 65, while the exterior surface of outer cover layer 108 may have a Shore D hardness of from about 40 to about 60. In some embodiments, the entirety of mantle layer 310 has a higher hardness than the entirety of cover 308.

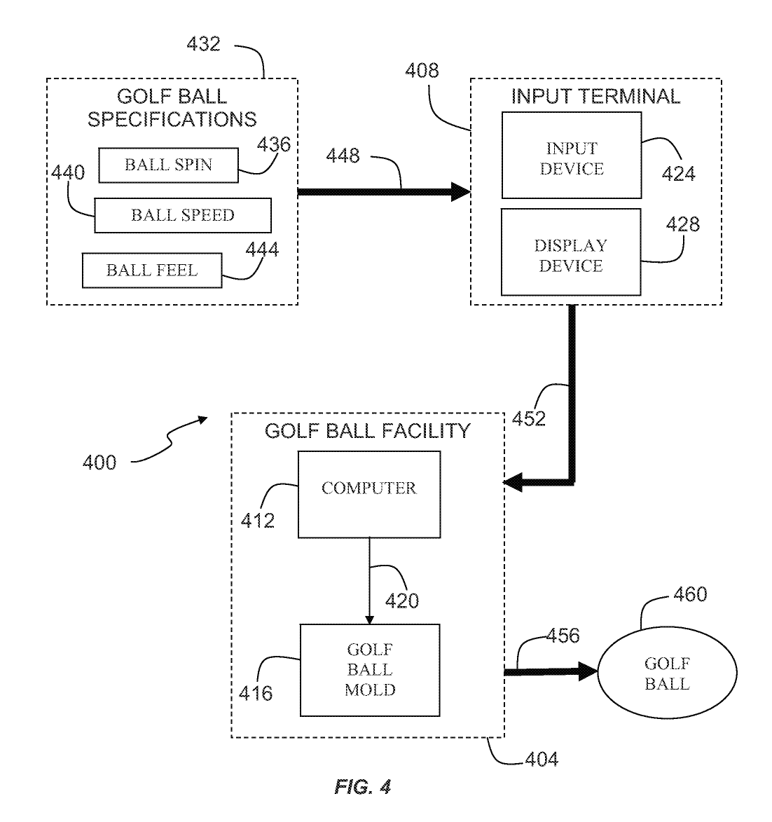

Embodiments of golf balls prepared according to FIGS. 1-3 may be obtained using an “on demand” blending system with identification of one or more golf ball specifications by a customer for controlling, for example, the blending of one or more highly neutralized acid polymers and one or more metallocene-catalyzed polymers in the inner core. One embodiment of such a system for an “on demand” blending is shown in FIG. 4, and is indicated generally as 400. As shown in FIG. 4, system 400 comprises a golf ball manufacturing facility, indicated generally as 404, and an input terminal, indicated generally as 408. Facility 404 may include a processor in the form of computer 412 which may receive electronic data (e.g., which includes the golf ball specifications identified by the customer) for controlling the manufacturer of golf balls by one or more golf ball molds 416, as indicated by arrow 420. (Although not shown FIG. 4, computer 412 may electronically access an electronic database either locally or remotely to obtain relevant data, such as core and cover compositions, core and cover materials, mold conditions, previous golf ball specifications of other customers or the same customer, etc., for preparing golf balls in golf ball mold 416.) Input terminal 408 may be located in remote electronic communication with facility 404 (e.g., computer 412), or may be located proximate facility 404. Input terminal includes an input device 424 (e.g., keyboard, touchscreen) and a display device (e,g., monitor, screen) 428. Where input device 424 is, for example, a touchscreen, the touchscreen may also function as display device 428.

As shown in FIG. 4, a customer may select one or more golf ball specifications, indicated generally as 432. These golf ball specifications 432 may include, as illustrated in FIG. 4, the amount of ball spin 436 desired, the ball speed 440 desired, the ball feel 444 desired, and any other selectable and customizable properties and characteristics. These selected golf ball specifications 432 may be entered, as indicated by arrow 448, into input terminal 408 (via input device 424) which then electronically transmits these golf ball specifications 432, as indicated by arrow 456, to facility 400. The transmitted golf ball specifications 452 may be received by computer processor 412 which then controls the formulation, processing, and other production steps, of the golf ball, including appropriately selecting and blending one or more highly neutralized acid polymers and one or more metallocene-catalyzed polymers in the inner core, as well as selecting appropriate materials for the outer core, optionally for the mantle layer between the outer core and the cover, and for the cover, molding conditions for use with golf ball molds 416, and other required parameters. Molds 416 then provide, as indicated by arrow 456, one or more golf balls 460 according to the transmitted golf ball specifications 452.

### EXAMPLES

Embodiments of golf balls in accordance with the present disclosure are fabricated, as described below.

For each golf ball, an inner core (IC) may be made from a composition selected from Table 1, an outer core (OC) may be made from a composition selected from Table 2, a cover layer (CL) may made from a composition selected from Table 3:

TABLE 1
Inner Core Compositions

| Inner Core Materials* | IC-1 | IC-2 | IC-3 | IC-4 | IC-5 | IC-6 |
|---|---|---|---|---|---|---|
| HPF 1000¹ | 50 | | 25 | 25 | | |
| HPF 2000² | | 50 | 25 | | 75 | 75 |
| Non-Grafted Metallocene- | 50 | | 25 | 75 | | 25 |
| Catalyzed Polymer³ | | | | | | |
| Grafted Metallocene- | | 50 | 25 | | 25 | |
| Catalyzed Polymer⁴ | | | | | | |

Notes for Table 1:
*Percentages by Weight
¹DuPont ionomer resin in which the acid groups have been neutralized with magnesium ions.
²DuPont ionomer resin in which the methylmethacrylate (MAA) acid groups have been fully neutralized with magnesium ions.
³AFFINITY ® and/or ENGAGE ® polyolefin elastomers.
⁴SURLYN ® NMO 525D, SURLYN ® NMO 524D, and/or SURLYN ® NMO 499D.

TABLE 2
Outer Core Compositions

| Outer Core Materials- | | |
|---|---|---|
| Parts by weight | OC-1 | OC-2 |
| HPF 2000 | 100 | 100 |
| Barium sulfate | 16 | 18 |

TABLE 3
Cover Layer Compositions

| Cover Materials** | CL-1 | CL-2 | CL-3 | CL-4 | CL-5 | CL-6 |
|---|---|---|---|---|---|---|
| Neothane TEI4511D⁵ | 100 | | | | | |
| Neothane TEI6025D⁶ | | 100 | | | | |
| Texin ® 245⁷ | | | 100 | | | |
| Texin ® 260⁸ | | | | 100 | | |
| Elastollan ® 1195A⁹ | | | | | 100 | |
| Surlyn ® 8940¹⁰ | | | | | | 50 |
| Surlyn ® 9910¹¹ | | | | | | 50 |

Notes for Table 3:
**Parts by weight. Titanium dioxide and UV-stabilizers typically are added to cover layer compositions of this type.
⁵Thermoplastic polyurethane (TPU) material
⁶Thermoplastic polyurethane (TPU) material
⁷Thermoplastic polyurethane resin by Bayer MaterialScience AG
⁸Thermoplastic polyurethane resin by Bayer MaterialScience AG
⁹Thermoplastic polyurethane resin by BASF
¹⁰Ionomeric resin by E. I. DuPont de Nemours and Company
¹¹Ionomeric resin by E. I. DuPont de Nemours and Company

From the above inner core compositions, outer core compositions, and cover layer compositions of Tables 1, 2, and 3, golf balls are manufactured using conventional injection molding processes known in the art of golf ball manufacturing, as shown in Table 4:

TABLE 4
Golf Balls

| | GB-1 | GB-2 | GB-3 | GB-4 | GB-5 | GB-6 | GB-7 | GB-8 |
|---|---|---|---|---|---|---|---|---|
| Inner | IC-1 | 1C-2 | IC-3 | IC-4 | IC-5 | IC-1 | IC-2 | IC-6 |
| Core (IC) | | | | | | | | |
| Outer | OC-1 | OC-2 | OC-1 | OC-2 | OC-1 | OC-2 | OC-1 | OC-2 |
| Core (OC) | | | | | | | | |
| Cover | CL-1 | CL-2 | CL-3 | CL-4 | CL-5 | CL-6 | CL-1 | CL-3 |
| Layer (CL) | | | | | | | | |

While various embodiments of the disclosure have been described, the description is intended to be exemplary, rather than limiting and it will be apparent to those of ordinary skill in the art that many more embodiments and implementations are possible that are within the scope of the disclosure. Accordingly, the disclosure is not to be restricted except in light of the attached claims and their equivalents. For example, additional dense filler can be present in the outer core, or in the outer cover, or an inner core can comprise density reducing compositions and therefore have a lower density. Also, various modifications and changes may be made within the scope of the attached claims.

What is claimed is:

1. A golf ball having a moment of inertia (MOI) of at least about 86 g-cm² and:
an inner core;
an outer core essentially surrounding the inner core; and
a cover essentially surrounding the outer core and having an outer surface comprising a dimple pattern comprising a plurality of dimples:
wherein the inner core comprises, by weight, a blend of from about 0.5 to 99.5% of one or more highly neutralized acid polymers and from about 0.5 to about 99.5% one or more metallocene-catalyzed polymers, based on the total weight of the polymers, and has a specific gravity between about 0.85 and 0.95; and
wherein the outer core comprises one or more highly neutralized acid polymers and a specific gravity greater than about 1.2.

2. The golf ball of claim 1, wherein the cover has a specific gravity greater than about 1.2.

3. The golf ball of claim 2, wherein the inner core has a diameter of from about 19 to about 40 mm, and wherein the outer core has a thickness of from about 0.1 mm to about 15 mm.

4. The golf ball of claim 3, wherein the golf ball inner core comprises from about 10 wt percent to about 90 wt percent highly neutralized acid polymers and from about 10 wt percent to about 90 wt percent metallocene-catalyzed polymers.

5. The golf ball of claim 1 wherein the COR of the inner core is at least about 0.785.

6. The golf ball of claim 5, wherein highly neutralized acid polymer is selected from the group consisting of HPF 1000, HPF 2000, HPF AD1027, HPF AD1035, HPF AD1040, members of the HPF SEP 1313 series, HPF RX-85, and blends thereof and the metallocene-catalyzed polymer comprises one or more metallocene-catalyzed polymers grafted with one or more pendant maleic, fumaric, itaconic, acrylic, or acrylate functional groups.

7. The golf ball of claim 6, wherein the metallocene-catalyzed polymers comprise one or more metallocene-catalyzed polymers grafted with maleic anhydride.

8. The golf ball of claim 1, wherein the outer core has a specific gravity of from about 1.2 to about 5.

9. The golf ball of claim 8, wherein the outer core further comprises one or more thermoplastic materials selected from the group consisting of polyamide resins, polyester resins, polyurethane resins, and blends thereof; thermoset materials selected from the group consisting of polyurethane elastomers, polyamide elastomers, polyurea elastomers, diene-containing polymers, silicones, and blends thereof; and blends of thermoplastic and thermoset materials.

10. A golf ball having a moment of inertia (MOI) of at least about 86 g-cm² and:
an inner core;
an outer core essentially surrounding the inner core; and
a cover essentially surrounding the outer core and having an outer surface comprising a dimple pattern comprising a plurality of dimples;
wherein the inner core comprises, by weight, a blend of from about 0.5 to 99.5% of one or more highly neutralized acid polymers and from about 0.5 to about 99.5% one or more metallocene-catalyzed polymers, based on the weight of the polymers, and a density reducing composition, and has a specific gravity between about 0.70 and 0.85; and
wherein the outer core comprises one or more highly neutralized acid polymers and a specific gravity greater than about 1.2.

11. The golf ball of claim 10, wherein the cover has a specific gravity greater than about 1.2.

12. The golf ball of claim 11, wherein the inner core has a diameter of from about 19 to about 40 mm, and wherein the outer core has a thickness of from about 0.1 mm to about 15 mm.

13. The golf ball of claim 12, wherein the golf ball inner core comprises from about 10 wt percent to about 90 wt percent highly neutralized acid polymers and from about 10 wt percent to about 90 wt percent metallocene-catalyzed polymers.

14. The golf ball of claim 10 wherein the COR of the inner core is at least about 0.750.

15. The golf ball of claim 14, wherein highly neutralized acid polymer is selected from the group consisting of HPF 1000, HPF 2000, HPF AD1027, HPF AD1035, HPF AD1040, members of the HPF SEP 1313 series, HPF RX-85, and blends thereof and the metallocene-catalyzed polymer comprises one or more metallocene-catalyzed polymers grafted with one or more pendant maleic, fumaric, itaconic, acrylic, or acrylate functional groups.

16. The golf ball of claim 15, wherein the metallocene-catalyzed polymers comprise one or more metallocene-catalyzed polymers grafted with maleic anhydride.

17. The golf ball of claim 10, wherein the outer core has a specific gravity of from about 1.2 to about 5.

18. The golf ball of claim 17, wherein the outer core further comprises one or more thermoplastic materials selected from the group consisting of polyamide resins, polyester resins, polyurethane resins, and blends thereof; thermoset materials selected from the group consisting of polyurethane elastomers, polyamide elastomers, polyurea elastomers, diene-containing polymers, silicones, and blends thereof; and blends of thermoplastic and thermoset materials.

19. A method comprising the following steps:
(a) providing one or more golf ball specifications to a golf ball making system; and
(b) based on the one or more golf ball specifications provided to the golf ball making system in step (a), preparing one or more golf balls comprising: an inner core; an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples; wherein the inner core comprises, by weight, a blend of from about 0.5 to about 99.5% of one or more highly neutralized acid polymers and from about 0.5 to about 99.5% one or more metallocene-catalyzed polymers, based on the weight of the polymers, and a specific gravity of at least about 0.70; wherein the outer core comprises one or more highly neutralized acid polymers and a specific gravity greater than about 1.2.

20. The method of claim 19, wherein the golf ball specifications of step (a) comprise one or more of: ball speed, degree of ball spin, materials comprising inner core, outer core, and/or cover, ball hardness, ball softness, ball feel, ball flight, ball launch angle, ball distance, degree of ball control, ball dimple pattern, ball dimple number, and total dimple volume.

21. The method of claim 20, wherein the golf ball specifications of step (a) comprise one or more of: ball speed; degree of ball spin; or ball feel.

22. A system comprising:
an input terminal for entering one or more golf ball specifications; and
a processor to which is electronically transmitted the golf ball specifications entered into the input terminal so that one or more golf balls can be prepared based on the transmitted golf ball specifications,
wherein the golf balls to be prepared comprise: an inner core; an outer core surrounding the inner core in a ratio (in terms of radius and mass) of inner core to outer core so as to provide a golf ball having a moment of inertia (MOI) of at least about 86 g-cm²; and a cover surrounding the outer core and having an outer surface comprising a dimple pattern comprising a plurality of dimples;
wherein the inner core comprises, by weight, a blend of from about 0.5 to 99.5% of one or more highly neutralized acid polymers and from about 0.5 to about 99.5% one or more metallocene-catalyzed polymers, based on the weight of the polymers, and a specific gravity of at least about 0.70; wherein the outer core comprises one or more highly neutralized acid polymers and a specific gravity greater than about 1.2.

23. The system of claim 22, wherein the input terminal is located in remote electronic communication with the computer.

24. The system of claim 23, wherein the input terminal comprises an input device and display device.
